(19) United States
(12) Patent Application Publication
(10) Pub. No.: US 2024/0098667 A1
(43) Pub. Date: Mar. 21, 2024

(54) TIMING ADJUSTMENT METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 18/039,486

(22) PCT Filed: Nov. 30, 2020
(86) PCT No.: PCT/CN2020/132913

§ 371 Date: May 30, 2023

(51) Int. Cl. H04W 56/00

(52) U.S. Cl. CPC H04W 56/003

(57) ABSTRACT

Embodiments of the present disclosure provide a timing adjustment method and apparatus, a communication device, and a storage medium. The method is applied to a terminal, and includes: according to downlink timing information, determining an adjustment approach for uplink transmitting timing information.

### CROSS REFERENCE TO RELATED APPLICATION

The present disclosure is the U.S. national phase application of International Application No. PCT/CN2020/132913 filed on Nov. 30, 2020, the content of which is incorporated herein by reference in its entirety for all purposes.

### BACKGROUND

In the field of wireless communication, relevant technologies define the UE (User Equipment) uplink initial transmission timing requirement. UE obtains downlink timing information by measuring the downlink reference signal SSB (Synchronization Signal Block), and adjusts next uplink transmission timing based on the downlink timing information obtained.

### SUMMARY

The present disclosure relates, but is not limited, to a field of wireless communication, and more particular to a method for adjusting timing and an apparatus, a communication device, and a storage medium.

According to a first aspect of the present disclosure, a method for adjusting timing is provided, which is applied to a terminal, and includes:
determining, according to downlink timing information, an adjustment approach for uplink transmission timing information.

According to a second aspect of the present disclosure, an apparatus for adjusting timing is provided, which is applied to a terminal, and includes: a first determination module configured to determine, according to downlink timing information, an adjustment approach for uplink transmission timing information.

According to a third aspect of the present disclosure, a communication device is provided, which at least includes a processor and a memory for storing executable instructions capable of running on the processor; wherein when the executable instructions run on the processor, steps of any of the methods for adjusting timing mentioned above are caused to be executed.

According to a fourth aspect of the present disclosure, non-transitory computer-readable storage medium is provided, which has computer executable instructions stored thereon, when the computer executable instructions are executed by a processor, steps of any of the methods for adjusting timing mentioned above are caused to be executed.

### BRIEF DESCRIPTION OF THE DRAWINGS

The drawings, which are incorporated in and constitute a part of this specification, illustrate embodiments consistent with the present disclosure and serve together with the specification to explain principles of the present disclosure.

FIG. 1 illustrates a schematic diagram of a structure of a wireless communication system according to some embodiments;

FIG. 2 illustrates a flowchart of a method for adjusting timing according to some embodiments;

FIG. 3 illustrates a flowchart of a method for adjusting timing according to some embodiments;

FIG. 4 illustrates a flowchart of a method for adjusting timing according to some embodiments;

FIG. 5 illustrates a schematic diagram of different timing adjustment approaches according to some embodiments;

FIG. 6 illustrates a structural block diagram of an apparatus for adjusting timing according to some embodiments;

FIG. 7 illustrates a schematic diagram of a structure of a communication device according to some embodiments;

FIG. 8 illustrates a schematic diagram of a structure of a communication device according to some embodiments.

### DETAILED DESCRIPTION

Some embodiments will be explained herein in detail, and examples are illustrated in the drawings. When referring to the drawings, unless otherwise indicated in the following descriptions, the same numerals in different drawings represent the same or similar elements. Implementations described in the following embodiments do not represent all implementations consistent with the present disclosure. Instead, they are only examples of devices and methods consistent with some aspects of embodiments of the present disclosure as detailed in the attached claims.

Terms used in embodiments disclosed in the present disclosure are for the purpose of description of specific embodiments only, and are not intended to limit the embodiments of the present disclosure. Singular forms such as “a” and “the” used in embodiments of the present disclosure and the attached claims are also intended to include plural forms, unless other meanings are clearly indicated in the context. It should also be understood that the term “and/or” used herein refers to and includes any or all possible combinations of one or more related items listed.

It should be understood that although terms such as first, second, and third may be used to describe various information in embodiments of the present disclosure, this information should not be limited to these terms, which are only used to distinguish information of the same type from each other. For example, without departing from the scope of the present disclosure, the first information can also be referred to as the second information, and similarly, the second information can also be referred to as the first information. The word “if” and “in case” used herein can be interpreted as “when”, “while” or “in response to determination that”, depending on the context.

In order to better describe embodiments of the present disclosure, an application scenario of access control is taken as an example for illustrative explanation in one embodiment of the present disclosure.

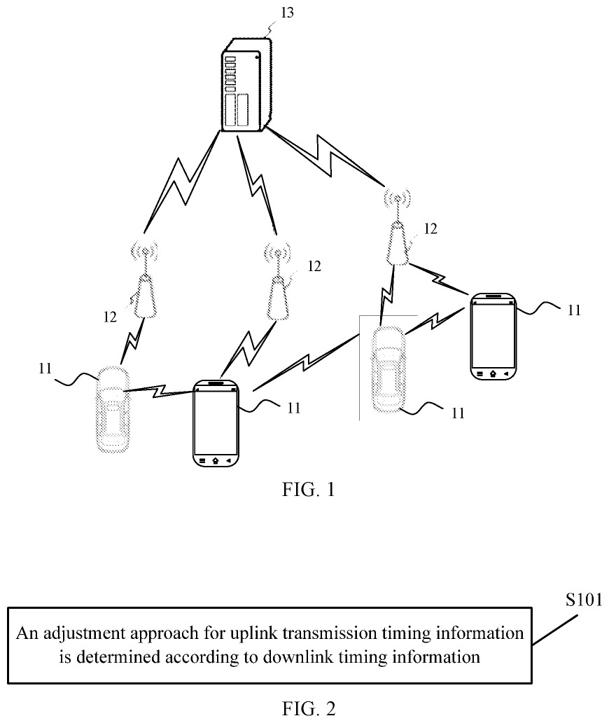

Reference is made to FIG. 1, which illustrates a schematic diagram of a structure of a wireless communication system provided by embodiments of the present disclosure. As shown in FIG. 1, the wireless communication system is a communication system based on cellular mobile communication technology, which may include several terminals 11 and several base stations 12.

The terminal 11 can be equipment that provides voice and/or data connectivity to a user. The terminal 11 can communicate with one or more core networks via a Radio Access Network (RAN). The terminal 11 can be an IoT (Internet of Things) terminal, for example, a sensor device, a mobile phone (or a “cellular” phone), and a computer with IoT terminals, such as fixed, portable, pocket, handheld, computer built-in, or vehicle mounted devices. For example, stations (STA), subscriber units, subscriber stations, mobile stations, mobiles, remote stations, access points, remote terminals, access terminals, user terminals, user agents, user devices or terminals. Alternatively, the terminal 11 can also be a device for unmanned aerial vehicles. Alternatively, the terminal 11 can also be an onboard device, such as a trip computer with wireless communication ability or wireless terminals connected to an external trip computer. Alternatively, the terminal 11 can also be a roadside device, such as a street light, a signal light, or other roadside devices with wireless communication ability.

Base station 12 can be a network side device in the wireless communication system. The wireless communication system can be the 4th generation (4G) mobile communication system, also known as Long Term Evolution (LTE) system. Alternatively, the wireless communication system can also be the 5th generation (5G) system, also known as New Radio system or 5G NR system. Alternatively, the wireless communication system can also be the next generation system following 5G system. The access network in 5G system can be referred to as the New Generation-Radio Access Network (NG-RAN).

Base station 12 can be the Evolved Node B (eNB) employed in 4G system. Alternatively, base station 12 can also be the next Generation Node B (gNB) constructed in a centralized and distributed architecture in 5G system. When constructed in the centralized and distributed architecture, base station 12 usually includes a central unit (CU) and at least two distributed units (DUs). The central unit is provided with a protocol stack consisting of the Packet Data Convergence Protocol (PDCP) layer, the Radio Link Control (RLC) layer, and the Medium Access Control (MAC) layer. The distributed unit is provided with a protocol stack of the Physical (PHY) layer. Specific implementations of base station 12 are not limited in embodiments of the present disclosure.

A wireless connection can be established between the base station 12 and the terminal 11 via a wireless air interface. In different implementations, the wireless air interface is based on the 4th generation (4G) mobile communication network technology standard. Alternatively, the wireless air interface is based on the 5th generation (5G) mobile communication network technology standard, for example, the wireless air interface is the New Radio. Alternatively, the wireless air interface can also be a wireless air interface based on the next generation mobile communication network technology standard following 5G.

In some embodiments, an E2E (End to End) connection can also be established between the terminal 11. For example, in vehicle to everything (V2X) communication, there are scenarios where vehicle to vehicle (V2V) communication, vehicle to infrastructure (V2I) communication, and vehicle to pedestrian (V2P) communication are established.

In some embodiments, the wireless communication system described above can also include a network management device 13.

Some of base stations 12 are respectively connected to the network management device 13. The network management device 13 can be a core network device in the wireless communication system, for example, the network management device 13 can be the Mobility Management Entity (MME) in the Evolved Packet Core (EPC). Alternatively, the network management device can also be other core network devices, such as the Service GateWay (SGW), the Public Data Network GateWay (PGW), the Policy and Charging Rules Function (PCRF), or the Home Subscriber Server (HSS). Implementations of the network management device 13 are not limited in embodiments of the present disclosure.

As shown in FIG. 2, embodiments of the present disclosure provide a method for adjusting timing. The method is applied to a terminal, and includes following steps.

In step S101, an adjustment approach for uplink transmission timing information is determined according to downlink timing information.

In some embodiments, the terminal can be any type of UE with wireless communication capability. For example, various types of terminals such as mobile phones, tablets, and smart watches.

In embodiments of the present disclosure, the uplink transmission timing information is synchronization information provided for ensuring the orthogonality between UE uplink signals, which is used to align time when uplink signals from different UEs arrive at the base station. UE needs to adjust the uplink transmission timing information during uplink transmission, so that an uplink transmission timing error meets a predetermined error condition, such as being less than a predetermined error threshold.

In embodiments of the present disclosure, the downlink timing information includes timing information for the terminal to receive a downlink signal, such as a time domain signal frame position or a symbol position where the time domain resource used for receiving the downlink signal is located. The terminal can determine the downlink timing information by receiving and measuring a downlink reference signal. The downlink timing information indicates to UE the synchronization between the downlink signal and the uplink signal. Based on the downlink timing information, UE can determine the uplink transmission timing information that is synchronized with the downlink signal timing, and then perform uplink transmission based on the uplink transmission timing information.

In some embodiments, when UE measures that RSRP (Reference Signal Receiving Power) of the downlink reference signal changes significantly or does not meet predetermined requirements, for example, when an RSRP value of another beam is greater than the current beam, a new Tx/Rx (transmit/receive) beam pairing process needs to be carried out. UE can then determine that the downlink timing information has changed significantly, resulting in a significant error in the uplink transmission timing, and it is necessary to adjust the uplink transmission timing information over a large range.

When sending of the Tx/Rx beam pair changes, the UE's receiving channel may change significantly, for example, from LOS (Line of sight) to NLOS (Non line of sight), UE's present transmission timing may change significantly, compared with UE's preceding transmission timing, due to different transmission delay. If a gradual adjustment method is adopted at this time, it may be difficult to adjust in a timely manner. Therefore, a one-time adjustment method can be used to ensure that the error of the uplink transmission timing information meets the predetermined requirements.

In embodiments of the present disclosure, different adjustment approaches for uplink transmission timing information can be adapted for downlink timing information in different situations, for example, one shot adjustment for uplink transmission timing information; gradual adjustment for uplink transmission timing information, which can be further performed so that an amplitude of each adjustment among different adjustments is different; or no adjustment for uplink transmission timing information, in which the current uplink transmission timing information is maintained, etc.

According to above embodiments, UE can adopt, according to the uplink transmission timing error, different adjustment approaches for uplink transmission timing information in different situations, thereby improving adjustment efficiency and reducing the impact on the transmission and reception performance of UE caused by untimely adjustment.

In some embodiments, that an adjustment approach for uplink transmission timing information is determined according to downlink timing information includes following steps. An uplink transmission timing error is determined according to the downlink timing information; and the adjustment approach for the uplink transmission timing information is determined according to the uplink transmission timing error.

In some embodiments, the uplink transmission timing error is an error between current uplink transmission timing and downlink signal timing. For example, the terminal obtains downlink signal timing through measurement based on the downlink reference signal received, and performs uplink data transmission at a corresponding adjacent time domain resource location (such as an (n+1)^{th} symbol position) based on the time domain resource location (such as an n^{th} symbol position) where the downlink reference signal is located. However, the uplink transmission timing error (for example, when the start time of the n+1 symbol bit is not synchronized with the end time of the n th symbol bit) may occur when determining the time domain resource location, due to computational biases from a terminal hardware. Therefore, in order to ensure the synchronization performance of the receiving of signals by the base station, it is necessary for the uplink transmission timing error to meet a predetermined error range. If the error range is not met and the thus the error is large, the out-of-sync information will be resulted, thereby affecting the signal transmission performance of UE.

In some embodiments, UE can determine a current uplink transmission timing error according to the downlink timing information. Due to the synchronization between the uplink transmission timing and the downlink timing, the uplink transmission information can be determined through the downlink timing information, and the uplink transmission timing error can be determined according to current downlink timing information and historical downlink timing information. By means of the downlink timing information, UE can learn that when a significant change in the downlink timing information occurs, it is necessory to adjust the uplink transmission timing information.

In some embodiments, if an error between the downlink timing information and the uplink transmission timing information of the uplink beam of preceding transmission is less than a predetermined threshold, the uplink transmission timing information can be finely adjusted by adopting a gradual adjustment approach, to meet predetermined requirements.

Embodiments of the present disclosure provide a timing adjustment method and an apparatus, a communication device, and a storage medium. According to embodiments of the present disclosure, different adjustment approaches for uplink transmission timing information can be determined based on the uplink transmission timing error. Compared with a unified gradual adjustment approach, flexible adjustments can be made under different channel changes. For example, in a case where the uplink transmission error is large, the uplink transmission error can be timely adjusted to an allowable error range, thereby reducing the impact on the transmission and reception performance of UE caused by untimely adjustment.

In some embodiments, the adjustment approach includes at least one of following approaches.

A first approach is to adjust the uplink transmission timing information in at least two steps until the uplink transmission timing error is less than or equal to a preset first error threshold.

A second approach is to adjust the uplink transmission timing information at one shot so that the uplink transmission timing error is less than or equal to the first error threshold. In embodiments of the present disclosure, the adjustment approach mentioned above includes at least two approaches, the first approach, and the second approach. The first approach is a gradual adjustment approach, which gradually adjusts the uplink transmission timing error to be less than the first error threshold.

The first error threshold is a maximum value of the error that may exist in the uplink transmission timing information. If the uplink transmission timing error is greater than the first error threshold, the transmission and reception performance of the UE will be affected. In such case, it is necessary to adjust the uplink transmission timing information so that the uplink transmission timing error is less than the first error threshold.

In some embodiments, the adjustment made according to the first approach mentioned above shall follow following rules:
first, a maximum amount of timing change in one adjustment is T_{q};
second, a minimum adjustment rate is Tₚ per second; and
third, a maximum adjustment rate is T_{q} per 200 ms.

In some embodiments, the values of T_{q} and Tₚ can vary under different uplink bandwidths, which can be specified by predetermined protocols.

The second approach is a one shot adjustment approach, which adjusts the uplink transmission timing information to a range within which the error is less than or equal to the first error threshold at one shot. As a result, the number of adjustments is reduced and the adjustment speed is improved, thereby reducing the impact on the transmission and reception performance of UE caused by untimely adjustment on uplink transmission timing, when a significant change in the channel due to changes in Tx/Rx beam pairs, as well as interference to uplink transmissions of other UEs.

In some embodiments, that the adjustment approach for the uplink transmission timing information is determined according to the uplink transmission timing error includes: in response to the uplink transmission timing error being greater than the first error threshold and less than or equal to a second error threshold, the adjustment approach for the uplink transmission timing information is determined to be the first approach; and/or,
in response to the uplink transmission timing error being greater than the second error threshold, the adjustment approach for the uplink transmission timing information is determined to be the second approach. The second error threshold herein is greater than or equal to the first error threshold.

In embodiments of the present disclosure, if the uplink transmission timing error is greater than the first error threshold, it is necessary to adjust the uplink transmission timing information so that an adjusted uplink transmission timing error is less than the first error threshold. If the uplink transmission timing error is greater than the first error threshold and less than or equal to the second error threshold, the adjustment on the uplink transmission timing information can be quickly completed through the gradual adjustment, so that the uplink transmission timing error is less than the first error threshold. Therefore, the first approach mentioned above can be adopted for such adjustment.

In a case where the uplink transmission timing error is greater than the second error threshold, if the uplink transmission timing information is gradually adjusted, it may be difficult to complete the adjustment in a timely manner, thereby affecting the transmission and reception performance of UE. Therefore, the second approach can be adopted for such adjustment, to adjust the uplink transmission timing information at one shot, so that the uplink transmission timing error is less than the first error threshold after the one shot adjustment.

In some embodiments, the downlink timing information includes:
first timing of a historical downlink beam; and
second timing of a current downlink beam.

In some embodiments, that the uplink transmission timing error is determined according to the downlink timing information includes:
the uplink transmission timing error is determined according to a difference between the first timing and the second timing.

In embodiments of the present disclosure, the second timing of the current downlink beam corresponds to the current uplink transmission timing information, while the first timing of the historical downlink beam corresponds to the historical uplink transmission timing information. Therefore, the uplink transmission timing error can be determined according to the difference between the first timing and the second timing mentioned above.

In some embodiments, the second timing of the historical downlink beam can be either timing of a preceding downlink beam or timing of a specified historical downlink beam.

In some embodiments, the difference between the first timing and the second timing herein is the difference between timings when the terminal receives the downlink beam at different moments. If the difference between the first timing and the second timing is less than the predetermined threshold for the uplink transmission timing error, the uplink transmission timing error corresponding to the uplink transmission timing information determined based on the current downlink timing information must be less than the predetermined threshold. Therefore, whether it is necessary to adjust the uplink transmission timing information can be determined based on the first timing and the second timing.

Due to the possibility of significant delay in receiving signals during movement of the terminal, the difference between the first timing and the second timing may be significant, and the uplink transmission timing error may also be significant. Therefore, in embodiments of the present disclosure, whether the uplink transmission timing error meets the predetermined threshold and whether an adjustment is necessary can be determined based on the difference between the first timing and the second timing.

In some embodiments, the timing of the downlink beam includes the time domain resource location occupied by the downlink beam, including a time domain frame number and/or a symbol position.

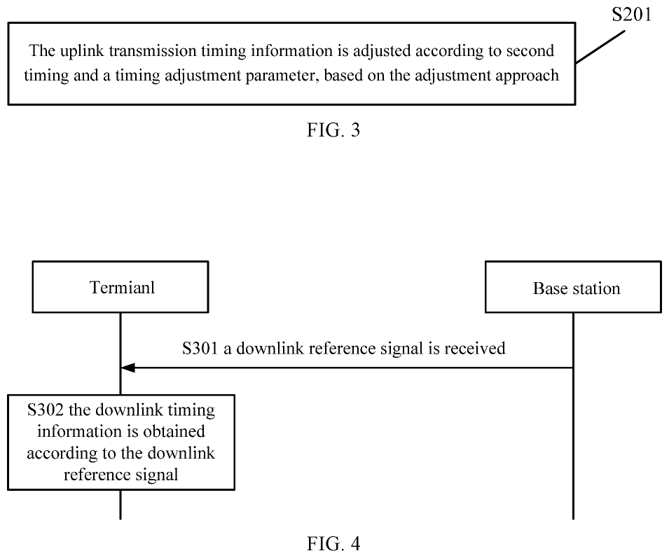

In some embodiments, as shown in FIG. 3, the method further includes following steps.

In step S201, the uplink transmission timing information is adjusted according to second timing and a timing adjustment parameter, based on the adjustment approach.

In some embodiments, the second timing is timing of the current downlink beam, which corresponds to timing of the current uplink beam. Therefore, the uplink transmission timing information can be adjusted according to the second timing and a predetermined timing adjustment parameter. For example, the uplink transmission timing in adjusted uplink transmission timing information is duration obtained by subtracting the adjustment parameter from the second timing, and an adjusted uplink transmission timing error is less than the predetermined threshold.

By using the first approach for gradual adjustment, at least two sets of timing adjustment parameters are used for the adjustment, respectively, on the basis of the second timing. For the second approach, the uplink transmission timing error is adjusted to be less than the predetermined threshold at one shot, on the basis of the second timing.

In some embodiments, the timing adjustment parameter includes:
a timing advance (TA) value; and
a timing adjustment offset value.

In some embodiments, the timing adjustment parameter may include the TA value and the timing adjustment offset value, values of which can be agreed by predetermined protocols.

In some embodiments, the second timing mentioned above is denoted as T2, the TA value is denoted as N_{TA}, and the timing adjustment offset value is denoted as N_{TA} offset, then the adjusted uplink transmission timing is: T2−(N_{TA}+N_{TA_offset}) T_{C}, where T_{C} is a time unit.

In some embodiments, the T_{A} value is an uplink timing advance amount, which is configured to represent difference between the uplink signal timing and timing when the terminal receives the downlink signal, that is, a negative offset between timing when the terminal sends the uplink signal and timing when the terminal receives the downlink signal. In order to ensure the orthogonality of the uplink transmission and avoid interference in the cell, uplink signals from different terminals received by the same base station need to be aligned in time. Therefore, the uplink transmission timing is adjusted through the uplink timing advance mechanism.

After receiving an instruction of timing advance adjustment, the terminal can determine an adjustment offset value of above timing advance amount according to the downlink timing information, thereby realizing the uplink transmission timing adjustment.

In some embodiments, as shown in FIG. 4, the method further includes following steps.

In step S301, a downlink reference signal is received.

In step S302, the downlink timing information is obtained according to the downlink reference signal.

In embodiments of the present disclosure, UE can obtain the downlink timing information mentioned above by receiving the downlink reference signal.

The downlink reference signal includes a cell specific reference signal (C-RS, Cell Reference Signal), a user specific reference signal (DM-RS, Demodulation Reference Signal), an MB SFN (Multimedia Broadcast multicast service Single Frequency Network Transmission Area) reference signal, a position reference signal (P-RS, Position Reference Signal) and a channel state reference signal (CSI-RS, Channel-State Information Reference Signal), etc.

The downlink reference signal is a known signal provided by the base station to UE for channel estimation or channel detection, which contains the downlink timing information.

In some embodiments, the downlink reference signal includes at least one of:
Synchronization Signal Block (SSB); and
Channel-State Information Reference Signal (CSI-RS).

In some embodiments, when the Tx/Rx beam changes, UE obtains the downlink timing information through the downlink reference signal SSB or CSI-RS. SSB or CSI-RS carries synchronization information, and UE can directly obtain corresponding downlink timing information.

In some embodiments, the method further includes:
timing adjustment capability information of the terminal is reported.

The timing adjustment capability information can be used to inform the base station the capability of the terminal to adjust the uplink transmission timing information.

In embodiments of the present disclosure, UE can also adjust the uplink transmission timing information based on whether itself has the capability to adjust the uplink transmission timing information through different approaches. If UE has the capability to adjust the uplink transmission timing information at one shot, it can be reported to the base station, so that the base station can learn a process of adjusting the uplink transmission timing information by UE, thereby facilitating subsequent signal transmission and processing of the base station.

Embodiments of the present disclosure also provide a method for adjusting timing, which is applied to a terminal, and includes the following step.

Based on the downlink timing information, the uplink transmission timing information is adjusted at one shot so that the uplink transmission timing error is less than or equal to the first error threshold.

In embodiments of the present disclosure, the downlink timing information includes the timing information for the terminal to receive the downlink signal, which can be determined by UE according to a synchronization signal or other timing information sent by a network device such as the base station. The downlink timing information may include a timing parameter and a synchronization parameter of the downlink reference signal. The downlink timing information can be information carried in the downlink reference signal received by UE, or it can be timing information obtained by detecting the downlink reference signal. The downlink timing information indicates the synchronization information of the UE downlink signal, and based on the downlink timing information, UE can determine the uplink transmission timing information correspondingly.

In embodiments of the present disclosure, the uplink transmission timing information can be adjusted, according to the downlink timing information, at one shot to a range in which the error is less than or equal to the first error threshold.

In some embodiments, the terminal can determine the uplink transmission timing error according to the downlink timing information, and adjust the uplink transmission timing information based on a predetermined first error threshold of the uplink transmission timing error, so that the uplink transmission timing error is less than or equal to the first error threshold after one shot adjustment, thereby meeting requirements for the uplink transmission.

Compared with the approach where the uplink transmission timing information is gradually adjusted, the number of adjustments is reduced and the adjustment speed is improved, thereby reducing the impact on the transmission and reception performance of UE caused by untimely adjustment on uplink transmission timing, when a significant change in the channel due to changes in Tx/Rx beam pairs, as well as interference to uplink transmissions of other UEs.

In some embodiments, the downlink timing information includes first timing of a historical downlink beam, and second timing of a current downlink beam.

That the uplink transmission timing information is adjusted, according to the downlink timing information, at one shot so that the uplink transmission timing error is less than or equal to the first error threshold, includes:
the uplink transmission timing information is adjusted, according to difference between the first timing and the second timing, at one shot so that the uplink transmission timing error is less than or equal to the first error threshold.

In some embodiments, that the uplink transmission timing information is adjusted, according to the downlink timing information, at one shot so that the uplink transmission timing error is less than or equal to the first error threshold, includes:
the uplink transmission timing information is adjusted according to the second timing and a timing adjustment parameter.

In some embodiments, the timing adjustment parameter includes a TA value and a timing adjustment offset value.

In some embodiments, the adjusted uplink transmission timing is: T2−(N_{TA}+N_{TA_offset})×T_{C}, where a value of N_{TA} is TA, N_{TA_offset} is the timing adjustment offset value, and T_{C} is a time unit.

Embodiments of the present disclosure also provide a following example.

Embodiments of the present disclosure provide a method for adjusting UE uplink transmission timing, which can effectively solve a scenario where, when sending the Tx/Rx beam pair changes, the UE uplink transmission timing can be determined based on different threshold values, to determine whether to perform a gradual adjustment or a one shot adjustment.

For convenience of description, the method is described by means of steps, but it is not necessary to follow this order completely.

In step 1, a terminal UE reports capability signaling indicating whether the terminal supports one-shot transmission timing adjustment.

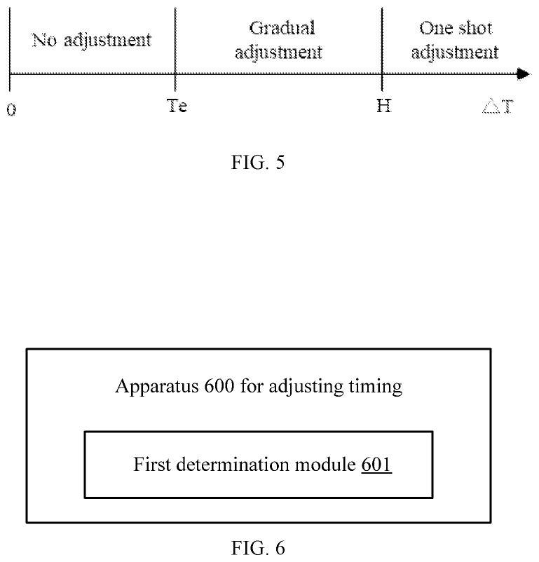

In step 2, UE obtains downlink timing information through the downlink reference signal SSB or CSI-RS when the Tx/Rx beam changes. The timing obtained by UE through a preceding downlink beam (old beam) is T1, and the timing obtained through a current downlink beam (new beam) is T2. The adjustment is shown in FIG. 5. If the difference (ΔT=T2−T1) between these two timings exceeds a threshold value H, UE adjusts the uplink transmission timing to be within Te based on a one shot approach. If ΔT is less than or equal to the threshold value H, UE adjusts the uplink transmission timing step by step based on a gradual approach.

In step 3, the DL reference timing after one-shot timing adjustment is a new beam after beam switching, the UE uplink transmission timing is T2−(N_{TA}+N_{TA_offset}) T_{C}, where N_{TA} is the timing advance, N_{TA_offset} is the timing adjustment offset value, and T_{C} is a time unit. Specific values of N_{TA_offset} are shown in Table 7.1.2-2 of 3GPP TS 38.133.

In step 4, a service base station can evaluate the UE transmission timing by receiving the uplink transmission signal from UE, for example, the timing difference (ΔT) is generated. When the timing difference is significant, the base station will determine whether to send a new T_{A} command based on the timing difference.

In step 5, step 2 is executed repeatedly.

According to above method for adjusting UE uplink transmission timing provided by embodiments of the present disclosure, it can effectively solve a senario where, when sending of the Tx/Rx beam pair changes, the UE uplink transmission timing can be determined based on different threshold values, to determine whether to perform a gradual adjustment or a one shot adjustment, thereby avoiding the impact on the transmission and reception performance of UE caused by untimely timing adjustment, as well as interference to uplink transmissions of other UEs.

As shown in FIG. 6, embodiments of the present disclosure also provide an apparatus 600 for adjusting timing, which is applied to a terminal, and includes a first determination module 601.

The first determination module 601 is configured to determine, according to downlink timing information, an adjustment approach for uplink transmission timing information. In some embodiments, the first determination module includes a first determination sub module and a second determination sub module.

The first determination sub module is configured to determine, according to the downlink timing information, an uplink transmission timing error.

The second determination sub module is configured to determine, according to the uplink transmission timing error, the adjustment approach for uplink transmission timing information.

In some embodiments, the adjustment approach includes at least one of a first approach and a second approach.

The first approach is configured to adjust the uplink transmission timing information in at least two steps until the uplink transmission timing error is less than or equal to a preset first error threshold.

The second approach is configured to adjust the uplink transmission timing information at one shot so that the uplink transmission timing error is less than or equal to the first error threshold.

In some embodiments, the first determination module includes a third determination sub module and a fourth determination sub module.

The third determination sub module is configured to determine, in response to the uplink transmission timing error being greater than the first error threshold and less than or equal to a second error threshold, the adjustment approach for uplink transmission timing information as the first approach.

The fourth determination sub module is configured to determine, in response to the uplink transmission timing error being greater than the second error threshold, the adjustment approach for uplink transmission timing information as the second approach, wherein the second error threshold is greater than or equal to the first error threshold.

In some embodiments, the downlink timing information includes:
first timing of a historical downlink beam; and
second timing of a current downlink beam.

The first determination sub module includes a fifth determination sub module.

The fifth determination sub module is configured to determine, according to a difference between the first timing and the second timing, the uplink transmission timing error.

In some embodiments, the apparatus further includes an adjustment module.

The adjustment module is configured to adjust, based on the adjustment approach, the uplink transmission timing information according to the second timing and a timing adjustment parameter.

In some embodiments, the timing adjustment parameter includes:
a timing advance (TA) value; and
a timing adjustment offset value.

In some embodiments, the apparatus further includes a receiving module and an obtaining module.

The receiving module is configured to receive a downlink reference signal.

The obtaining module is configured to obtain the downlink timing information through the downlink reference signal.

In some embodiments, the downlink reference signal includes at least one of:
Synchronization Signal Block (SSB); and
Channel-State Information Reference Signal (CSI-RS).

In some embodiments, the apparatus further includes a reporting module.

The reporting module is configured to report timing adjustment capability information of the terminal.

Specific ways in which each module of the apparatus in above embodiments performs operations have been described in detail in related method embodiments, and will not be explained in detail herein.

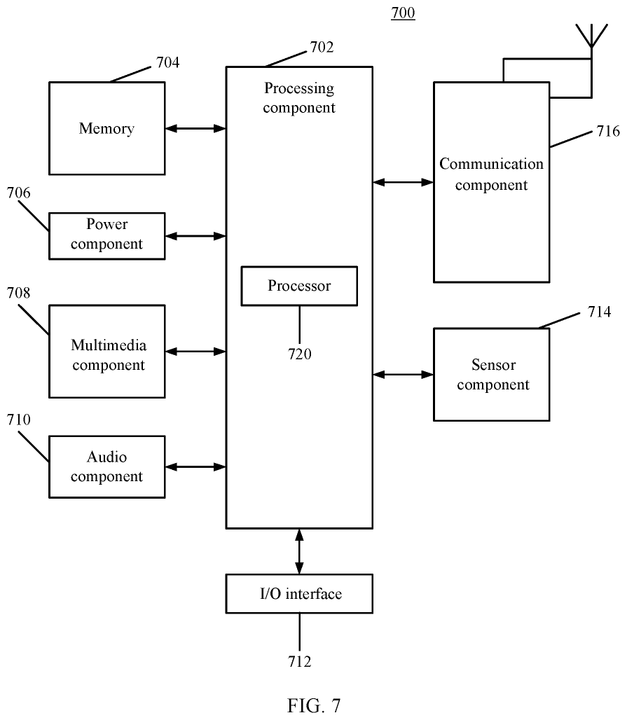

FIG. 7 illustrates a schematic diagram of a structure of a communication device according to some embodiments. The communication device can be a terminal. For example, communication device 700 can be a mobile phone, a computer, a digital broadcasting user device, a messaging device, a game console, a tablet device, a medical device, a fitness device, a personal digital assistant, etc.

Referring to FIG. 7, communication device 700 can include at least one of the following components: a processing component 702, a memory 704, a power component 706, a multimedia component 708, an audio component 710, an input/output (I/O) interface 712, a sensor component 714, and a communication component 716.

The processing component 702 typically controls the overall operation of the communication device 700, such as operations associated with display, telephone call, data communication, camera operation, and recording operations. The processing component 702 may include one or more processors to execute instructions to complete all or part of the methods described above. In addition, the processing component 702 may include one or more modules to facilitate interactions between the processing component 702 and other components. For example, the processing component 702 may include a multimedia module to facilitate interaction between the multimedia component 708 and the processing component 702.

The memory 704 is configured to store various types of data to support operations in the communication device 700. Examples of such data include instructions, contact data, phone book data, messages, pictures, videos, and the like for any application or method operating on the communication device 700. The memory 704 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 706 provides power for various components of the communication device 700. The power component 706 may include a power management system, one or more power supplies, and other components associated with generating, managing, and distributing power for the communication device 700.

The multimedia component 708 includes a display screen providing an output interface between the communication device 700 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 708 includes a front camera and/or a rear camera. When the communication device 700 is in operation mode, such as shooting mode or video mode, the front camera and/or rear camera can receive external multimedia data. Each front camera and rear camera can be a fixed optical lens system or have focal length and optical zoom capability.

The audio component 710 is configured to output and/or input audio signals. For example, the audio component 710 includes a microphone (MIC), which is configured to receive an external audio signal when the communication device 700 is in an operation mode, such as a calling mode, a recording mode, and a voice recognition mode. The received audio signal may be further stored in memory 704 or transmitted via communication component 716. In some embodiments, the audio component 710 also includes a speaker for outputting audio signals.

The I/O interface 712 provides an interface between the processing component 702 and peripheral interface modules, which can be a keyboard, click wheel, button, etc. These buttons may include, but are not limited to, the Home button, Volume button, Start button, and Lock button.

The sensor component 714 includes one or more sensors for providing various aspects of condition evaluation for the communication device 700. For example, the sensor component 714 can detect an open/closed state of the communication device 700, relative positioning of the components. The component is, for example, a display and a keypad of the communication device 700. The sensor component 714 can also detect changes in the position of the communication device 700 or one component of the communication device 700, presence or absence of the user's contact with the communication device 700, orientation or acceleration/deceleration of the communication device 700 and temperature change of the communication device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an acceleration sensor, a gyroscope sensor, a magnetic sensor, a pressure sensor, or a temperature sensor.

The communication component 716 is configured to facilitate wired or wireless communication between the communication device 700 and other devices. The communication device 700 can access wireless networks based on communication standards, such as WiFi, 2G or 3G, or a combination thereof. In some embodiments, the communication component 716 receives a broadcast signal or broadcast related information from an external broadcast management system via a broadcast channel. In some embodiments, the communication component 716 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the communication device 700 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 704 including instructions, which can be executed by a processor of the communication device 700 to complete above methods. For example, the non-transitory computer-readable storage medium can be ROM, random access memory (RAM), CD-ROM, tapes, floppy disks, optical data storage devices, etc.

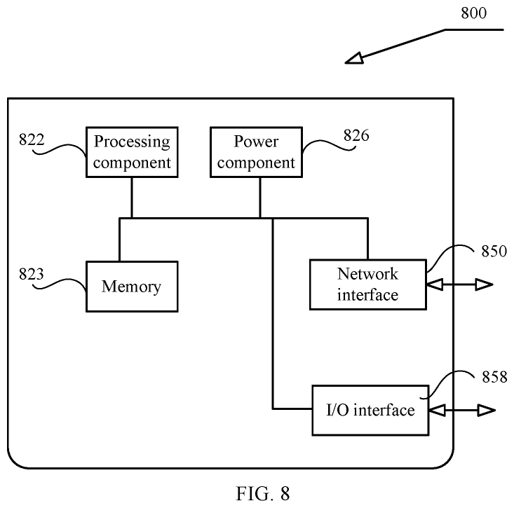

As shown in FIG. 8, embodiments of the present disclosure illustrate a structure of another communication device. The communication device can be a base station according to embodiments of the present disclosure. For example, communication device 800 can be provided as a network side device. Referring to FIG. 8, the communication device 800 includes a processing component 822, which further includes one or more processors, as well as memory resources represented by a memory 832, for storing instructions that can be executed by the processing component 822, such as application programs. The application programs stored in memory 832 may include one or more modules corresponding to a set of instructions. In addition, the processing component 822 is configured to execute instructions to execute any of the methods applied to the base station described above.

The communication device 800 may also include a power component 826 configured to perform power management of the communication device 800, a wired or wireless network interface 850 configured to connect the communication device 800 to the network, and an input and output (I/O) interface 858. The communication device 800 can operate operating systems stored on the memory 832, such as Windows Server™, Mac OS X™, Unix™, Linux™, FreeBSD™, or similar systems.

The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

It should be understood that the present disclosure is not limited to the precise structure described above and shown in the drawings, and various modifications and changes can be made without departing from its scope. The scope of the present disclosure is limited only by the appended claims.

1. A method for adjusting timing, performed by a terminal, comprising:
determining, according to downlink timing information, an adjustment approach for uplink transmission timing information.

2. The method according to claim 1, wherein determining, according to downlink timing information, an adjustment approach for uplink transmission timing information comprises:
determining, according to the downlink timing information, an uplink transmission timing error; and
determining, according to the uplink transmission timing error, the adjustment approach for uplink transmission timing information.

3. The method according to claim 2, wherein the adjustment approach comprises:
a first approach configured to adjust the uplink transmission timing information in at least two steps until the uplink transmission timing error is less than or equal to a preset first error threshold; or
a second approach configured to adjust the uplink transmission timing information at one shot so that the uplink transmission timing error is less than or equal to the first error threshold.

4. The method according to claim 3, wherein determining, according to the uplink transmission timing error, the adjustment approach for uplink transmission timing information comprises:
determining, in response to the uplink transmission timing error being greater than the first error threshold and being less than or equal to a second error threshold, the adjustment approach for uplink transmission timing information as the first approach; or
determining, in response to the uplink transmission timing error being greater than the second error threshold, the adjustment approach for uplink transmission timing information as the second approach;
wherein the second error threshold is greater than or equal to the first error threshold.

5. The method according to claim 2,
wherein the downlink timing information comprises a first timing of a historical downlink beam and a second timing of a current downlink beam; and
wherein determining, according to the downlink timing information, an uplink transmission timing error comprises:
determining, according to a difference between the first timing and the second timing, the uplink transmission timing error.

6. The method according to claim 5, further comprising:
adjusting, based on the adjustment approach, the uplink transmission timing information according to the second timing and a timing adjustment parameter.

7. The method according to claim 6, wherein the timing adjustment parameter comprises at least one of:
a timing advance (TA) value; and
a timing adjustment offset value.

8. The method according to claim 1, further comprising:
receiving a downlink reference signal; and
obtaining the downlink timing information through the downlink reference signal.

9. The method according to claim 8, wherein the downlink reference signal comprises at least one of:
Synchronization Signal Block (SSB); and
Channel-State Information Reference Signal (CSI-RS).

10. The method according to claim 1, further comprising:
reporting timing adjustment capability information of the terminal.

11-20. (canceled)

21. A communication device, comprising at least a processor and a memory for storing executable instructions capable of running on the processor, wherein when the executable instructions run on the processor, the processor is configured to:
determine, according to downlink timing information, an adjustment approach for uplink transmission timing information.

22. (canceled)

23. The device according to claim 21, wherein the processor is further configured to:
determine, according to the downlink timing information, an uplink transmission timing error; and
determine, according to the uplink transmission timing error, the adjustment approach for uplink transmission timing information.

24. The device according to claim 23, wherein the adjustment approach comprises:
a first approach configured to adjust the uplink transmission timing information in at least two steps until the uplink transmission timing error is less than or equal to a preset first error threshold; or
a second approach configured to adjust the uplink transmission timing information at one shot so that the uplink transmission timing error is less than or equal to the first error threshold.

25. The device according to claim 24, wherein the processor is further configured to:
determine, in response to the uplink transmission timing error being greater than the first error threshold and being less than or equal to a second error threshold, the adjustment approach for uplink transmission timing information as the first approach; or
determine, in response to the uplink transmission timing error being greater than the second error threshold, the adjustment approach for uplink transmission timing information as the second approach;
wherein the second error threshold is greater than or equal to the first error threshold.

26. The device according to claim 23,
wherein the downlink timing information comprises a first timing of a historical downlink beam and a second timing of a current downlink beam; and
wherein the processor is further configured to:
determine, according to a difference between the first timing and the second timing, the uplink transmission timing error.

27. The device according to claim 26, wherein the processor is further configured to:
adjust, based on the adjustment approach, the uplink transmission timing information according to the second timing and a timing adjustment parameter.

28. The device according to claim 27, wherein the timing adjustment parameter comprises at least one of:
a timing advance (TA) value; and
a timing adjustment offset value.

29. The device according to claim 21, wherein the processor is further configured to:
receive a downlink reference signal; and
obtain the downlink timing information through the downlink reference signal.

30. The device according to claim 29, wherein the downlink reference signal comprises at least one of:
Synchronization Signal Block (SSB); and
Channel-State Information Reference Signal (CSI-RS).

31. The device according to claim 21, wherein the processor is further configured to:
report timing adjustment capability information of a terminal.
